(19) United States
(12) Patent Application Publication
(10) Pub. No.: US 2021/0222053 A1
(43) Pub. Date: Jul. 22, 2021

(54) Methods and Compositions for Use in Oil and Gas Operations

(71) Applicant: Halliburton Energy Services, Inc., Houston, TX (US)

(72) Inventors: Paul D. LORD, Cypress, TX (US); Philip D. NGUYEN, Houston, TX (US); Megan R. PEARL, Spring, TX (US); Scott A. GALE, Spring, TX (US)

(21) Appl. No.: 16/744,639

(22) Filed: Jan. 16, 2020

(51) Int. Cl. C09K 8/68; E21B 43/04; E21B 43/267; C09K 8/575

(52) U.S. Cl. CPC C09K 8/68; C09K 8/5753; E21B 43/267; E21B 43/04

(57) ABSTRACT

Disclosed herein is a method for use in oil and gas operations comprising prepackaging, in a packaging container, two or more dry components to form a dry composition, wherein the two or more dry components comprise a polyacrylamide friction reducer (FR) polymer, and wherein the dry composition comprises a predetermined ratio of the two or more dry components, transporting the packaging container to a wellsite, removing all or a portion of the dry composition from the packaging container and mixing the all or a portion of the dry composition with an aqueous fluid to form a wellbore servicing fluid having known concentrations of the two or more dry components, and placing at least a portion of the wellbore servicing fluid into a wellbore penetrating a subterranean formation.

### BACKGROUND

This disclosure relates to methods of preparing compositions for use in oil and gas operations. More specifically, it relates to methods of prepackaging compositions and using same in oil and gas operations.

Natural resources such as gas, oil, and water residing in a subterranean formation or zone are usually recovered by drilling a wellbore down to the subterranean formation. Fluids (e.g., production fluids) in the subterranean formation are driven into the wells by, for example, pressure gradients that exist between the subterranean formation and the wells, the force of gravity, displacement of the fluids using pumps, or the force of another fluid injected into the wells. The production of such fluids is commonly increased by hydraulically fracturing the subterranean formations. That is, a fracturing fluid is pumped into a wellbore to a subterranean formation at a rate and a pressure sufficient to form fractures that extend into the subterranean formation, providing additional pathways through which the fluids can flow to the wellbore. Proppant, such as grains of sand of a particular size or a range of sizes, is mixed with the fracturing fluid to keep the fracture open when the treatment by the fracturing fluid is complete.

Many subterranean formations are unconsolidated or poorly consolidated. Thus, loose sand grains may undesirably flow into an adjacent production well, contaminating the fluid being recovered from the well. The sand could cause severe erosion of well equipment and could plug the flow passages into the well such that an expensive workover of the well is required. Methods commonly utilized to prevent migration of sand into wells and to maintain the integrity of subterranean formations include gravel packing and frac-packing. A permeable screen is placed against the face of a subterranean formation, followed by packing gravel or particulate material against the exterior of the screen. The gravel or the particulate material is typically carried to the subterranean formation by suspending the gravel or the particulate material in a so-called gravel packing fluid or a frac-pack fluid, respectively, and pumping the fluid to the formation. The screen blocks the passage of the gravel or the particulate material but not the fluid into the subterranean formation such that the screen prevents the gravel or the particulate material from being circulated out of the hole, which leaves the gravel or the particulate material in place. The gravel or the particulate material is separated from the fluid as the fluid flows through the screen leaving it deposited on the exterior of the screen. A wellbore servicing fluid (e.g., a fracturing fluid, a gravel packing fluid, a frac-pack fluid) is usually prepared at the wellsite, where the ingredients (e.g., a gelling agent, a surfactant.) are blended with a fluid (e.g., water) to form a pumpable composition that is placed into the wellbore during an associated wellbore servicing operation such as fracturing, gravel packing, or frac-packing.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a flow chart of a method according to some embodiments of the disclosure.

FIG. 2 is a flow chart of a method according to some embodiments of the disclosure.

FIG. 3 is a flow chart of a method according to some embodiments of the disclosure.

FIG. 4 is a simplified schematic view of a wellbore and a servicing fluid treatment system for the treatment of a wellbore servicing fluid according to some embodiments of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

It is to be understood that “subterranean formation” encompasses both areas below exposed earth and areas below earth covered by water such as ocean or fresh water. Herein in the disclosure, “top” means the well at the surface (e.g., at the wellhead which may be located on dry land or below water, e.g., a subsea wellhead), and the direction along a wellbore towards the well surface is referred to as “up”; “bottom” means the end of the wellbore away from the surface, and the direction along a wellbore away from the wellbore surface is referred to as “down”. For example, in a horizontal wellbore, two locations may be at the same level (i.e., depth within a subterranean formation), the location closer to the well surface (by comparing the lengths along the wellbore from the wellbore surface to the locations) is referred to as “above” the other location.

The disclosure involves prepackaging a dry mixture and optionally an add-on dry composition, transporting the dry mixture and optionally the add-on dry composition to a wellsite to prepare a wellbore servicing fluid, and using the wellbore servicing fluid at the wellsite. The method can simplify the process of making the wellbore servicing fluid at the wellsite. The dry mixture and/or the add-on dry composition are dry mixed using compositions that are predetermined. The dry mixture and/or the add-on dry composition can have various predetermined compositions to be suitable for different purposes and wellbore conditions.

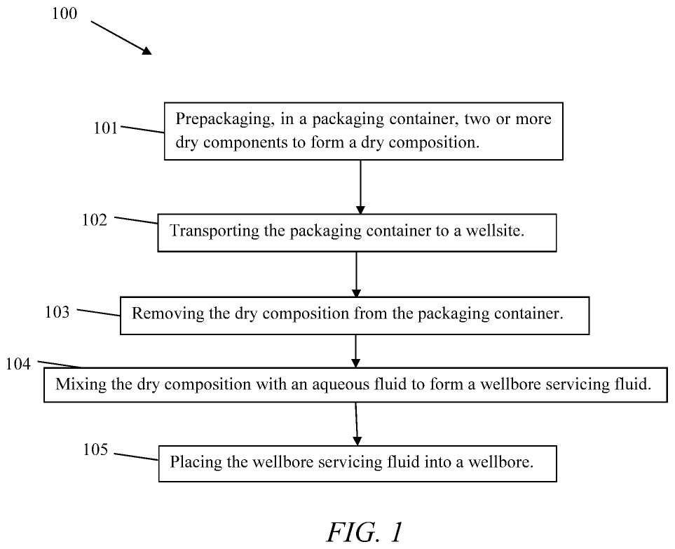

FIG. 1 illustrates a method 100 for use in oil and gas operations according to this disclosure. Block 101 includes prepackaging, in a packaging container, two or more dry components to form a dry composition. The two or more dry components can comprise a polyacrylamide friction reducer (FR) polymer, and the dry composition can comprise a predetermined ratio of the two or more dry components. Block 102 includes transporting the packaging container to a wellsite. Block 103 includes removing all or a portion of the dry composition from the packaging container. Block 104 includes mixing the all or a portion of the dry composition with an aqueous fluid to form a wellbore servicing fluid having known concentrations of the two or more dry components. Block 105 includes placing at least a portion of the wellbore servicing fluid into a wellbore penetrating a subterranean formation. The mixing the all or a portion of the dry composition with an aqueous fluid to form a wellbore servicing fluid at block 104 and the placing at least a portion of the wellbore servicing fluid into a wellbore penetrating a subterranean formation at block 105 can comprise a continuous process (also referred to as an “on-the-fly” process). A continuous process or an “on-the-fly” process means the one or more steps in the process are running on a continuous basis. For example, a blending or mixing step can be continuous in that the dry composition and the aqueous fluid are contacted in a blender or mixer in a manner that yields an about constant output of a wellbore servicing fluid from the blender or mixer. In embodiments, the continuous process further comprises removing all or a portion of the dry composition from the packaging container at block 103. The blender, mixer, and other process equipment can operate at about steady state conditions during a continuous process, with the understanding that one or more operational parameters (e.g., rate, pressure, etc.) in the continuous process can be adjusted during the process. The continuous process can be performed by using proper equipment (e.g., mixer, blender, feeders, pumps, etc.) and process management/control. For example, at the wellsite, continuously removing all or a portion of the dry composition from the packaging container (block 103) can be by a metering system (e.g., a solids feeder such as an auger or screw); continuously mixing the all or a portion of the dry composition with an aqueous fluid to form a wellbore servicing fluid (block 104) can be by a mixer or blender; continuously adding the aqueous fluid to the mixer or blender can be via a pump; continuously placing at least a portion of the wellbore servicing fluid into a wellbore penetrating a subterranean formation (block 105) can be by one or more pumps (e.g., one or more high pressure positive displacement pumps); and any combination thereof may be employed in a continuous process of the type described herein.

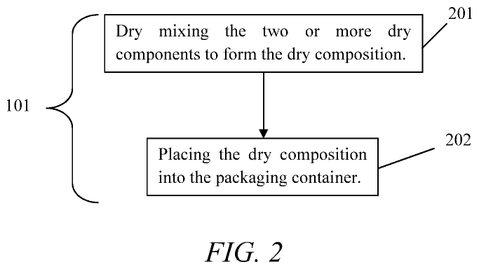

As in FIG. 2, in embodiments, the prepackaging at block 101 can further comprise blocks 201 and 202. Block 201 includes dry mixing the two or more dry components to form the dry composition. Block 201 can be in a mixing container. The two or more dry components can be added to the mixing container and be dry mixed therein. The mixing container can be any container that is compatible with the two or more dry components and has sufficient space for the two or more dry components. A blender can be used for dry mixing. Block 202 includes placing the dry composition into the packaging container.

The dry mixing the two or more dry components to form the dry composition at block 201 can be carried out at two or more separate locations. The two or more separate locations can comprise a first location of dry mixing a portion of the two or more dry components to form an intermediate dry mixture, and a second location of dry mixing the intermediate dry mixture with another portion of the two or more dry components to form the dry composition. For example, a portion of the two or more dry components can be dry mixed at a polyacrylamide FR polymer manufacturing site to form an intermediate dry mixture, and the intermediate dry mixture can be transported to a warehouse, where the intermediate dry mixture can be dry mixed with another portion of the two or more dry components. Transporting of the intermediate dry mixture can be done by a trailer (e.g., a pneumatic trailer, a Fruehauf trailer), railcar, or any transportation. During transporting, the intermediate dry mixture can be in the mixing container or a temporary container. In embodiments, the two or more dry components can be added into a container at a first location, the container can be transported to a second location, and the two or more dry components can be dry mixed at the second location (e.g., a mixing facility). Each of the two or more dry components can be included at an appropriated amount based on the amount of the polyacrylamide FR polymer to provide designed wellbore servicing fluid properties and performance.

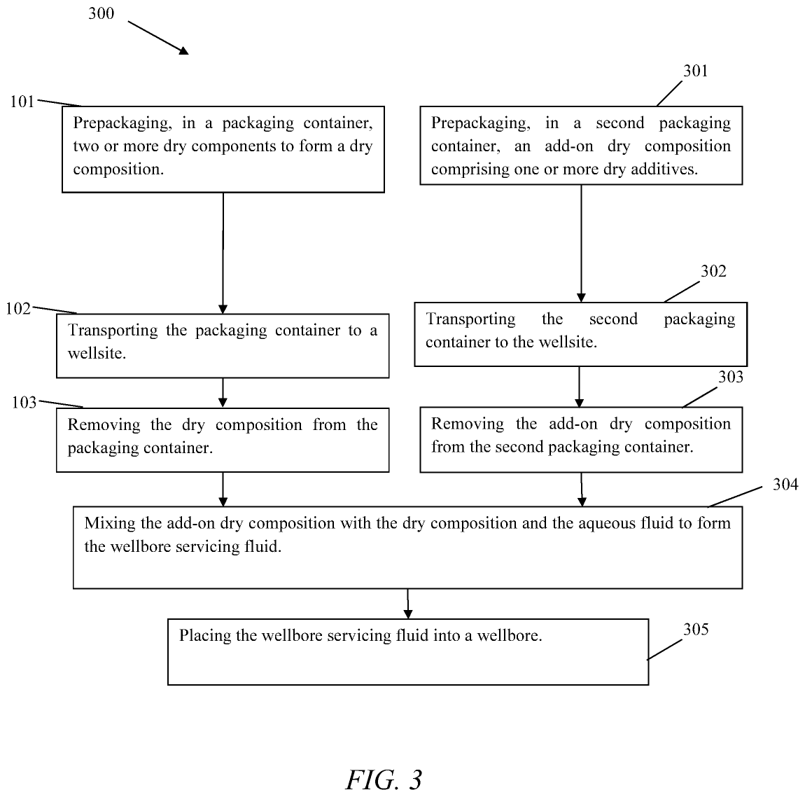

In addition to the two or more dry components, the dry composition and associated methods can include an add-on dry composition. The blocks 101, 102, and 103 as disclosed in FIG. 1 can be combined with further steps to form a method 300 as illustrated in FIG. 3. Block 301 includes prepackaging, in a second packaging container, an add-on dry composition comprising one or more dry additives. Block 302 includes transporting the second packaging container to the wellsite. Block 303 includes removing all or a portion of the add-on dry composition from the second packaging container. Block 304 includes mixing the all or a portion of the add-on dry composition with the dry composition and the aqueous fluid to form the wellbore servicing fluid having known concentrations of the one or more dry additives and known concentrations of the two or more dry components. Block 305 includes placing at least a portion of the wellbore servicing fluid into the wellbore. Block 305 is the same as block 105, except that the ingredients of the wellbore servicing fluid can be different.

The method can further comprise: prepackaging, in a second packaging container, an add-on dry composition comprising one or more dry additives; transporting the second packaging container to the wellsite and removing all or a portion of the add-on dry composition from the second packaging container; and prior to placing at least a portion of the wellbore servicing fluid into the wellbore, mixing the all or a portion of the add-on dry composition with the dry composition and the aqueous fluid to form the wellbore servicing fluid having known concentrations of the one or more dry additives, wherein the mixing the all or a portion of the add-on dry composition with the dry composition and the aqueous fluid to form the wellbore servicing fluid at block 304 is part of the continuous process. Additionally, the removing all or a portion of the add-on dry composition from the second packaging container at block 303 can be part of the continuous process.

The method 300 can involve two or more separate locations for prepackaging (e.g., blocks 101 and 301). The prepackaging, in the packaging container, the two or more dry components to form the dry composition at block 101 can be at a first location, and the prepackaging, in the second packaging container, the add-on dry composition comprising the one or more dry additives at block 301 can be at a second location that is separate from the first location. For example, the first location can be a polyacrylamide FR polymer manufacturing site, and the second location can be a warehouse. Each of the one or more dry additives in the add-on dry composition can be included at an appropriated amount based on the amount of the polyacrylamide FR polymer to provide designed wellbore servicing fluid properties and performance. In embodiments, the prepackaging at block 101 can be carried out at two or more locations. In embodiments, the prepackaging at block 301 can be carried out at two or more locations. In embodiments, when the dry mixing the two or more dry components to form the dry composition at block 101 is carried out at two or more separate locations, the method can further comprise: prepackaging, in a second packaging container, an add-on dry composition comprising one or more dry additives; transporting the second packaging container to the wellsite and removing all or a portion of the add-on dry composition from the second packaging container; and prior to placing at least a portion of the wellbore servicing fluid into a wellbore, mixing the all or a portion of the add-on dry composition with the dry composition and the aqueous fluid to form the wellbore servicing fluid having known concentrations of the one or more dry additives, wherein the prepackaging, in the second packaging container, the add-on dry composition comprising the one or more dry additives at block 301 can be at a third location that is separate from the first and second locations.

The packaging container(s) can be sealed during the transporting and opened at the wellsite. The sealing can protect the dry composition and/or the add-on dry composition from being lost or contaminated during transportation. The packaging container(s) can be selected from the group consisting of totes having a tapered bottom, sacks (e.g., super sacks), railcars (e.g., pneumatic railcars), commercial trailers (e.g., pneumatic trailers, Fruehauf trailers). The packaging container(s) can have a tapered bottom, so that content removal by gravity can be enhanced when needed. The packaging container(s) can have an opening near the tapered bottom to allow the content removal. The packaging container(s) can have pneumatic systems to assist with loading and/or unloading of the dry composition.

The dry composition and/or the add-on dry composition can be continuously removed from the packaging container(s) by metering. The metering can be done by any solid metering system (e.g., a gauge, a solid feeder, an auger or screw). In embodiments, the dry composition and/or the add-on dry composition can be combined with the aqueous fluid in a mixer or blender during preparation of the wellbore servicing fluid, for example via a continuous or on-the-fly process wherein an about continuous flow rate of wellbore servicing fluid is prepared and removed from the mixer or blender. In embodiments, one or more components of the dry composition or one or more dry additives of the add-on dry composition can be combined with the aqueous fluid (e.g., water) via any suitable method including in-line mixing, direct injection, mixing, blending, spray mixing, etc.

The wellbore servicing fluid can be used to carry out a variety of associated wellbore servicing operations. For example, a wellbore servicing fluid prepared in accordance with the present disclosure can be used in, without limitation, hydraulic fracturing operations, gavel packing operations, frac-packing operations, and the like.

In embodiments, the dry composition can be a dry fracturing composition and the wellbore servicing fluid can be a fracturing fluid suitable for use in a hydraulic fracturing operation. The method can further comprise placing all or a portion of the fracturing fluid into the wellbore, wherein all or a portion of the fracturing fluid flows through a perforated interval of the wellbore and into the subterranean formation as part of a hydraulic fracturing treatment. The hydraulic fracturing treatment (or referred to as “fracturing treatment”) is a stimulation treatment performed on oil and gas wells in low-permeability reservoirs. Specially engineered fluids (e.g., a fracturing fluid) are pumped at high pressure and rate into the reservoir interval to be treated causing fractures to open. Wings of the fracture can extend away from the wellbore, for example in opposing directions according to the natural stresses within subterranean formation. Proppant can be mixed with the fracturing fluid to keep the fracture open when the treatment by the fracturing fluid is complete. The fracturing fluid without a proppant can be referred to as a proppant-less fluid. In some treatments, a proppant-less fluid is pumped into the formation to induce and propagate fractures in the formation, and a proppant slurry is pumped after the proppant-less fluid to provide proppant into the newly formed fractures to prop open same. In embodiments, the proppant-less fluid may be a low viscosity fracturing fluid sometimes referred to as “slickwater”.

Hydraulic fracturing creates high-conductivity communication with a large area of subterranean formation and bypasses any damage that may exist in the near-wellbore area. The perforated interval refers to a section of a wellbore that has been prepared for production by creating channels (e.g., perforations) between the wellbore and the subterranean formation surrounding the wellbore. In many cases, a long section will be perforated in several intervals, creating holes in casing or liner to achieve efficient communication between the subterranean formation and the wellbore. The wellbore can have casing disposed therein.

In the methods as disclosed herein, placing all or a portion of the fracturing fluid into the wellbore can be at a pressure greater than the fracture gradient, which is the pressure required to induce fractures in the subterranean formation at a given depth, so that the all or a portion of the fracturing fluid can flow through the perforated intervals and generate one or more fractures in the subterranean formation.

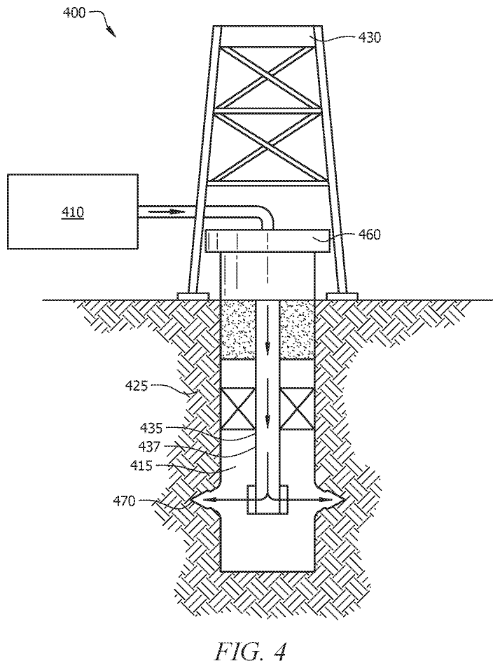

At the wellsite, the prepackaged dry composition and/or the prepackaged add-on dry composition can be mixed with an aqueous fluid to prepare a wellbore servicing fluid, for example a fracturing fluid used in a hydraulic fracturing operation. Referring to FIG. 4, an operating environment of the hydraulic fracturing operation comprises a wellsite 400 including a wellbore 415 penetrating a subterranean formation 425. A servicing fluid treatment (SFT) system 410 for the treatment of a wellbore servicing fluid is deployed at a wellsite 400 and is fluidly coupled to the wellbore 415 via a wellhead 460. A drilling or servicing rig 430 may generally comprise a derrick with a rig floor through which a tubular string 435 (e.g., a drill string; a work string, such as a segmented tubing, coiled tubing, jointed pipe, or the like; a casing string; or combinations thereof) having an inner flow surface or bore 437 may be lowered into the wellbore 415. The fracturing fluid may be introduced, at a relatively high-pressure, into the wellbore 415. The fracturing fluid may then be introduced into a portion of the subterranean formation 425 at a rate and/or pressure sufficient to initiate, create, or extend one or more fractures 470 within the subterranean formation 425. Proppants (e.g., grains of sand, glass beads, shells, ceramic particles, etc.,) may be mixed with the fracturing fluid, for example, so as to keep the fractures open (e.g., to “prop” the fractures) such that hydrocarbons may flow into the wellbore 415 so as to be produced from the subterranean formation 425. Hydraulic fracturing may create high-conductivity fluid communication between the wellbore 415 and the subterranean formation 425, for example, to enhance production of fluids (e.g., hydrocarbons) from the formation.

As noted previously, proppant can be mixed with the fracturing fluid to keep the fracture open when the treatment by the fracturing fluid is complete. The method as disclosed herein can further comprise: mixing a proppant with all or a portion of the fracturing fluid to form a proppant slurry; and placing all or a portion of the proppant slurry into the wellbore, wherein all or a portion of the proppant slurry flows through a perforated interval of the wellbore and into the subterranean formation as part of a hydraulic fracturing treatment. The proppant slurry can also be referred to as a proppant laden fluid.

Similar as preparing the fracturing fluid, mixing a proppant with all or a portion of the fracturing fluid to form a proppant slurry can be at the wellsite. A blender can be used for blending. The proppant can be added to the fracturing fluid during preparation thereof (e.g., during blending) and/or on-the-fly by addition to (e.g., injection into) the fracturing fluid when being pumped into the wellbore. The dry fracturing composition and the proppant, or the dry fracturing composition, the add-on dry composition, and the proppant can be added to the aqueous fluid during preparation thereof (e.g., during blending) and/or on-the-fly by addition to (e.g., injection into) the aqueous fluid when being pumped into the wellbore, and can be part of a continuous process as described herein.

Placing the proppant slurry into the wellbore can be at a pressure greater than the fracture gradient, so that the proppant slurry can flow through the perforated interval into the subterranean formation, prop the formation structures apart, extend the length of the one or more fractures, and place the proppant in the one or more fractures. Upon the release of the pressure, all or a portion of the fracturing fluid component (e.g., flowable, liquid component) of the proppant slurry can be removed from the wellbore. The solid proppant (e.g., sand) can stay in the one or more fractures to hold the fractures open.

The proppant slurry is a pumpable fluid that comprises a proppant. The proppant is a particulate matter (e.g., graded sand, bauxite, or resin coated sand), and is often dispersed throughout the proppant slurry. The proppant is suspended in the proppant slurry such that it can be deposited into the fracture created by the pressure exerted on the proppant slurry. The presence of the proppant in the fractures holds the fractures open after the pressure exerted on the fracturing fluid has been released. Otherwise, the fractures would close, rendering the fracturing operation useless. Ideally, the proppant has sufficient compressive strength to resist crushing.

The proppant can comprise a naturally-occurring material, a synthetic material, or a combination thereof. The proppant can comprise any suitable particulate matter, which can be used to prop fractures open, i.e., a propping agent or a proppant. When deposited in a perforation or a formation fracture, the proppant may form a proppant pack, resulting in conductive channels through which fluids may flow to the wellbore. The proppant functions to prevent the perforation or the formation fracture from closing due to overburden pressures. The proppant can also be used in a gravel packing or a frac-pack treatment.

Nonlimiting examples of proppants suitable for use in this disclosure include silica (sand), graded sand, Ottawa sands, Brady sands, Colorado sands; resin-coated sands; gravels; synthetic organic particles, nylon pellets, high density plastics, teflons, rubbers, resins; ceramics, aluminosilicates; glass; sintered bauxite; quartz; aluminum pellets; ground or crushed shells of nuts, walnuts, pecans, almonds, ivory nuts, brazil nuts, and the like; ground or crushed seed shells (including fruit pits) of seeds of fruits, plums, peaches, cherries, apricots, and the like; ground or crushed seed shells of other plants (e.g., maize, corn cobs or corn kernels); crushed fruit pits or processed wood materials, materials derived from woods, oak, hickory, walnut, poplar, mahogany, and the like, including such woods that have been processed by grinding, chipping, or other form of particleization; or combinations thereof.

The proppant can be of any suitable size and/or shape. Proppant particle size may be chosen by considering a variety of factors such as the particle size and distribution of the formation sand to be screened out by the proppant. In embodiments, a proppant suitable for use in the present disclosure can have a mean particle size in the range of from about 2 to about 800 mesh, alternatively from about 8 to about 200 mesh, or alternatively from about 10 to about 70 mesh, U.S. Sieve Series. The proppant can be present in the proppant slurry in an amount of to provide a proppant concentration ranging from greater than 0 pounds per gallon (ppg) to about 20 ppg, alternatively from about 0.1 ppg to about 8 ppg, or alternatively from about 0.5 ppg to about 4 ppg, based on the total weight of the proppant slurry. The proppant can be present in the proppant slurry in an amount of from about 0 wt. % to about 70 wt. %, based on the total weight of the proppant slurry.

The wellbore servicing fluid can also be utilized in sand control treatments, such as gravel packing. In gravel packing treatments, a wellbore servicing fluid (e.g., a gravel packing fluid) suspends particulates (commonly referred to as “gravel particulates” or “gravel”) to be deposited in a desired area in a well bore, e.g., near unconsolidated or weakly consolidated formation zones, to form a gravel pack to enhance sand control. One common type of gravel-packing operation involves placing a wellbore screen for sand control (e.g., a gravel pack screen) in the well bore and packing the annulus between the wellbore screen and the wellbore (or casing if the wellbore is cased) with the gravel particulates of a specific size designed to prevent the passage of formation sand. A conduit (e.g., a production pipe, a drilling pipe) can be disposed in the wellbore (open or cased). One end of the wellbore screen can be coupled to one end of the conduit directly or indirectly. The size of the gravel particulates used for this purpose can be larger than the formation sand particles but are also small enough to ensure that the formation sand cannot pass through voids between the gravel particulates. The gravel particulates act, inter alia, to prevent the formation sand particles from occluding the wellbore screen or migrating with the produced hydrocarbons, and the wellbore screen acts, inter alia, to prevent the formation sand particles from entering the production tubing. Once the gravel pack is substantially in place, the viscosity of the wellbore servicing fluid may be reduced to allow it to be recovered.

In embodiments, the dry composition can be a dry gravel packing composition (e.g., a dry composition as described herein, optionally an add-on dry composition as described herein, and gravel) and the wellbore servicing fluid can be a gravel packing fluid. The method as disclosed herein can further comprise: mixing gravel with all or a portion of the wellbore servicing fluid to form the gravel packing fluid; and placing all or a portion of the gravel packing fluid into the wellbore, wherein the wellbore has a perforated interval having a wellbore screen disposed proximate thereto that forms an annular space between the wellbore wall and the wellbore screen, and wherein the gravel packing fluid flows into the annular space and deposits the gravel therein.

The dry gravel packing composition can comprise gravel. The gravel can be the same or different from the proppant. The gravel in the dry gravel packing composition can comprise solid particles that can be suspended in the gravel packing fluid. The median size of the gravel particles can be larger in diameter than the median particle size of the formation sand. Preferably, the median size of the gravel particles are also small enough to ensure that the formation sand particles cannot pass through the openings between the gravel particles once the gravel particles have been deposited on the wellbore wall or within perforation tunnels. Examples of materials that can be used to form the gravel include, but are not limited to, graded siliceous sand, spherical glass beads, ceramic materials, and bauxite. Any of the foregoing materials may be coated with one or more thermally activated phenolic resins, epoxy compounds, and/or tackifiers. The amount of the gravel in the gravel packing fluid can range from about 0.1 pounds per gallon (ppg) to about 30 ppg, alternatively from about 1 ppg to about 15 ppg, or alternatively from about 1 ppg to about 10 ppg, based on the total weight of the gravel packing fluid.

In some situations, fracturing and gravel packing treatments are combined into a single treatment which can be referred to as “frac-pack” treatment. The “frac-pack” treatment is generally completed with a wellbore screen (e.g., a gravel pack screen) in place and with a wellbore servicing fluid (e.g., a frac-pack fluid) having suspended particulate material being pumped down through an annular space between the wellbore wall (or casing if the wellbore is cased) and the wellbore screen. A conduit (e.g., a production pipe, a drilling pipe) can be disposed in the wellbore (open or cased). One end of the wellbore screen can be coupled to one end of the conduit directly or indirectly. The wellbore servicing fluid can end in a screen-out condition, i.e., particulate material larger than a certain size determined by the wellbore screen can be screened out by the wellbore screen and stay in the annular space, creating an annular gravel pack between the screen and the wellbore wall (or casing if the wellbore is cased), while the rest of the wellbore servicing fluid can flow back up through the inside of the conduit. In other embodiments, the fracturing treatment can be performed prior to installing the wellbore screen and placing a gravel pack.

In embodiments, the dry composition can be a dry frac-pack composition (e.g., a dry composition as described herein, optionally an add-on dry composition as described herein, and particulate material such as gravel and sand) and the wellbore servicing fluid can be a frack-pack fluid. The method as disclosed herein can further comprise: mixing a particulate material with all or a portion of the wellbore servicing fluid to form the frac-pack fluid; and placing all or a portion of the frac-pack fluid into the wellbore, wherein the wellbore has a perforated interval having a wellbore screen disposed proximate thereto that forms an annular space between the wellbore wall and the wellbore screen, and wherein the frac-pack fluid flows into the annular space and through a perforated interval of the wellbore and into the subterranean formation, and wherein the particulate material is deposited into the subterranean formation as part of a hydraulic fracturing treatment and the particulate material is deposited in the annular space as part of a gravel packing treatment.

The dry frac-pack composition can comprise a particulate material. The particulate material can be the same or different from the proppant (e.g., sand) and/or the gravel. The particulate material can be present in the frac-pack fluid in an amount of from greater than 0.1 pounds per gallon (ppg) to about 30 ppg, alternatively from about 0.5 ppg to about 15 ppg, or alternatively from about 1 ppg to about 10 ppg, based on the total weight of the frac-pack fluid.

The two or more dry components can comprise a polyacrylamide FR polymer. After hydrating, the polyacrylamide FR polymer can provide designed friction reduction property and/or the proppant transport properties to the wellbore servicing fluid and/or the proppant slurry. The polyacrylamide FR polymer can comprise at least one polymer selected from the group consisting of: a polyacrylamide, a polyacrylamide derivative, a polyacrylamide co-polymer, and combinations thereof. The polyacrylamide FR polymer can be an anionic, cationic, non-ionic, or amphoteric polymer.

The polyacrylamide FR polymer can comprise at least one monomer derived from a compound selected from the group consisting of a carboxylic acid-substituted (C₂-C₂₀)alkene; a (C₂-C₂₀)alkylene oxide; a ((C₁-C₂₀)hydrocarbyl (C₁-C₂₀)alkanoic acid ester)-substituted (C₂-C₂₀)alkene; a ((C₁-C₂₀)alkanoic acid salt)-substituted (C₂-C₂₀)alkene; a (C₁-C₂₀)alkanoyloxy(C₁-C₂₀)hydrocarbyl tri(C₁-C₂₀)hydrocarbylammonium salt; a (substituted or unsubstituted amide)-substituted (C₂-C₂₀)alkene; a sulfonic acid-, sulfonic acid (C₁-C₂₀)hydrocarbyl ester-, or sulfonic acid salt-substituted (C₂-C₂₀)alkene; a (sulfonic acid (C₁-C₂₀)hydrocarbyl ester-, or sulfonic acid salt-substituted (C₁-C₂₀)hydrocarbylamido)-substituted (C₂-C₂₀)alkene; an N—(C₂-C₂₀)alkenyl (C₂-C₂₀)alkanoic acid amide; and a mono-, di-, tri-, or tetra-(C₂-C₂₀)alkenyl-substituted ammonium salt wherein the ammonium group is further substituted or unsubstituted; and combinations thereof wherein each hydrocarbyl, alkene, alkylene, alkanoic, and alkanoyl group is independently interrupted or terminated with 0, 1, 2, or 3 groups chosen from —O—, —NH—, and —S—, wherein each hydrocarbyl, alkene, alkylene, alkanoic, and alkanoyl group is independently further substituted or further unsubstituted.

The polyacrylamide FR polymer can comprise at least one monomer derived from a compound selected from the group consisting of acrylamide, acrylic acid or a salt thereof, 2-acrylamido-2-methylpropane sulfonic acid or a salt thereof, N,N-dimethylacrylamide, vinyl sulfonic acid or a salt thereof, N-vinyl acetamide, N-vinyl formamide, itaconic acid or a salt thereof, methacrylic acid or a salt thereof, acrylic acid ester, methacrylic acid ester, diallyl dimethyl ammonium chloride, dimethylaminoethyl acrylate, acryloyloxy ethyl trimethyl ammonium chloride, ethylene oxide, 2-(2-ethoxyethoxy)-ethyl acrylate, and combinations thereof.

The polyacrylamide FR polymer can be a polymer comprising about Z1 mol % of an ethylene repeating unit comprising a —C(O)NHR¹ group and comprising about N1 mol % of an ethylene repeating unit comprising a —C(O)R² group, wherein at each occurrence R¹ is independently a substituted or unsubstituted C₅-C₅₀ hydrocarbyl, at each occurrence R² is independently selected from a group consisting of —NH₂ and OR³, wherein at each occurrence R³ is independently selected from a group consisting of —R′, —H, and a counterion; wherein the ethylene repeating units are in block, alternate, or random configuration, and wherein Z1 mol % is from about 0.001% to about 50%, N1 mol % is from about 50% to about 99.999%, and Z1+N1 mol % is about 100%.

The one or more dry additives can comprise a surfactant, a breaker, a pH-adjusting agent, an anti-caking agent, a diverting or bridging agent, a chelating agent, a biocide, a de-emulsifier, a salt, a crosslinking agent, an anti-moisture agent, a degradable or non-degradable fiber material, a buffer, a clay inhibitor, an iron-control additive, a caustic, a scale inhibitor, a corrosion inhibitor, a relative permeability modifier, a curable resin, a resin activator, a tackifying agent, a surface modification agent, a nano-particle, or combinations thereof.

The one or more dry additives can comprise an anionic surfactant selected from a group consisting of sodium lauryl sulfate, alpha olefin sulfonate, alkylether sulfates, alkyl phosphonates, alkane sulfonates, fatty acid salts, arylsulfonic acid salts, and combinations thereof a cationic surfactant selected from a group consisting of trimethylcocoammonium chloride, trimethyltallowammonium chloride, dimethyldicocoammonium chloride, bis(2-hydroxyethyl)tallow amine, bis(2-hydroxyethyl)erucylamine, bis(2-hydroxyethyl)coco-amine, cetylpyridinium chloride, and combinations thereof or combinations thereof. The weight ratio of the polyacrylamide FR polymer to the surfactant is in a range of 0.1:10 to 10:1, alternatively in a range of 1:5 to 5:1.

The one or more dry additives can comprise a breaker. The breaker can be used to reduce viscosity of the wellbore servicing fluid and/or the proppant slurry. The breaker can comprise an instant breaker, a delayed breaker, or combinations thereof. The breaker can comprise an oxidizer, an acid, an enzyme, or combinations thereof. The breaker can comprise a hemicellulase enzyme, sodium persulfate, sodium perborate, ammonium persulfate, sodium chlorite, citric acid, citrate, fumaric acid, perborates, peroxides, or combinations thereof. The weight ratio of the polyacrylamide FR polymer to the breaker can be in a range of 0.1:10 to 10:1, alternatively in a range of 1:5 to 5:1.

The one or more dry additives can comprise an anti-caking agent. The anti-caking agent can also be referred to as an anti-compacting, or flowing enhancing agent. The anti-caking agent can prevent compacting, thereby enhancing flowing of a dry mixture during its removal from a container. The presence of the flowing enhancing agent in a dry mixture allows the dry mixture to be removed by gravity, or by mechanically or pneumatically conveyed out of storage tanks, even when the dry mixture is tightly packed therein.

The anti-caking agent can comprise a particulate solid material selected from a group consisting of precipitated silica, zeolite, magnesium stearate, calcium stearate, aluminum stearate, docusate sodium, sodium bicarbonate, cellulose, tricalcium phosphate, sodium ferrocyanide, potassium ferrocyanide, sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, polydimethylsiloxane, diatomaceous earth, sodium chloride, vermiculite, magnesium sulfate, and calcium sulfate. The anti-caking agent can be present in the dry composition and/or in the add-on dry composition in a range of from about 0.01 wt. % to about 1 wt. %, based on the total weight of the dry composition and/or in the add-on dry composition, alternatively in a range of from about 0.01 wt. % to about 0.9 wt. %, alternatively in a range of from about 0.01 wt. % to about 0.7 wt. %.

The one or more dry additives can comprise a crosslinking agent. The crosslinking agent can be selected from a group consisting of boron compounds, compounds that supply zirconium IV ions, compounds that supply titanium IV ions, aluminum compounds, compounds that supply antimony ions, and combinations thereof. The weight ratio of the polyacrylamide FR polymer to the crosslinking agent can be in a range of 0.1:10 to 10:1, alternatively in a range of 1:5 to 5:1.

The one or more dry additives can comprise a degradable or non-degradable fiber material. The degradable or non-degradable fiber material can enhance vertical and lateral distribution of proppant placement in created fractures. The degradable or non-degradable fiber material can comprise vegetable fibers, wood fibers, human fibers, animal fibers, mineral fibers, metallic fibers, carbon fibers, silicon carbide fibers, fiberglass fibers, cellulose fibers, polymer fibers, polyamide fibers, nylon fibers, polyethylene fibers, polypropylene fibers, polyethylene terephthalate fibers, poly(vinyl alcohol) fibers, polyolefin fibers, acrylic polyester fibers, aromatic polyamide fibers, elastomeric polymer fibers, glass fibers, polyurethane fibers, or combinations thereof. The weight ratio of the polyacrylamide FR polymer to the degradable or non-degradable fiber material can be in a range of 0.1:10 to 10:1, alternatively in a range of 1:5 to 5:1.

The one or more dry additives can comprise a diverting or bridging agent. The diverting or bridging agent can comprise a fine sand, a degradable polymer, or combinations thereof. The diverting or bridging agent can comprise at least one polymer selected from a group consisting of a polysaccharide, chitin, chitosan, a protein, an orthoester, an aliphatic polyester, a polyglycolide, polylactide, poly(vinyl alcohol), an esterified poly(vinyl alcohol), polycaprolactone, polyhydroxybutyrate, a polyanhydride, an aliphatic polycarbonate, a polyorthoester, a poly(amino acid), a poly(ethylene oxide), a polyphosphazene, a copolymer including monomers from at least two polymers chosen from the group, and combinations thereof.

The diverting or bridging agent can have a shape of platelets, shavings, flakes, ribbons, rods, strips, spheroids, toroids, pellets, tablets, or any other physical shape. The weight ratio of the polyacrylamide FR polymer to the diverting or bridging agent can be in a range of 0.1:10 to 10:1, alternatively in a range of 1:5 to 5:1.

The one or more dry additives can comprise an anti-moisture agent. The anti-moisture agent can be used to prevent compacting and hardening of the dry composition and/or the add-on dry composition into a solid mass. The anti-moisture agent can be a hygroscopic substance that is used to induce or sustain a state of dryness (desiccation) in its vicinity. Common anti-moisture agents include activated charcoal, calcium sulfate, calcium chloride, and molecular sieves (e.g., zeolites).

The two or more dry components can further comprise a gelling polymer. After hydrating in water, the gelling polymer can increase the viscosity and/or provide delayed crosslinking capability to the wellbore servicing fluid and/or the proppant slurry. The gelling polymer can reduce leakage of liquid from the fractures into the subterranean formation and improve proppant suspension capability. The gelling polymer can be a polymeric material that absorbs water and forms a gel as it undergoes hydration.

The gelling polymer can comprise a guar-based polymer (e.g., guar, hydroxypropyl guar, carboxymethyl guar, carboxymethylhydroxyethyl guar); a cellulose derivative selected from a group consisting of carboxymethylcellulose, carboxymethylhydroxyethylcellulose, hydroxyethylcellulose, methylhydroxypropylcellulose, methylcellulose, ethylcellulose, propylcellulose, ethylcarboxymethylcellulose, methylethylcellulose, hydroxypropylmethylcellulose, and combinations thereof a biopolymer selected from a group consisting of xanthan, scleroglucan, succinoglycan, and combinations thereof or combinations thereof. The weight ratio of the polyacrylamide FR polymer to the gelling polymer can be in a range of from about 0.1:10 to about 10:1, alternatively in a range of from about 1:5 to about 5:1.

The wellbore servicing fluid can comprise an aqueous fluid. The aqueous fluid can comprise water selected from a group consisting of freshwater, seawater, saltwater, brine (e.g., natural brine, formulated brine, etc.), and combinations thereof. The formulated brine may be produced by dissolving one or more soluble salts in water, a natural brine, or seawater. Representative soluble salts include the chloride, bromide, acetate, and formate salts of potassium, sodium, calcium, magnesium, and zinc. Generally, the water may be from any source, provided that it does not contain an amount of components that may undesirably affect the other components in the wellbore servicing fluid. The water can be present in the wellbore servicing fluid in an amount effective to provide a slurry having desired (e.g., job or service specific) rheological properties such as density, viscosity, gel strength, yield point, etc. The aqueous fluid is present in the wellbore servicing fluid in an amount of from about 1 wt. % to about 99.99 wt. %, alternatively from about 30 wt. % to about 99 wt. %, alternatively from about 50 wt. % to about 90 wt. %.

In embodiments, the dry composition can be packaged in one packaging container. A method for use in oil and gas operations can comprise: dry mixing two or more dry components to form a dry composition, wherein the two or more dry components comprise a polyacrylamide FR polymer and one or more components selected from the group consisting of a gelling polymer, one or more dry additives, and combinations thereof, and wherein the dry composition comprises a predetermined ratio of the two or more dry components; placing the dry composition in a packaging container; transporting the packaging container to a wellsite; removing all or a portion of the dry composition from the packaging container; mixing the all or a portion of the dry composition with an aqueous fluid to form a wellbore servicing fluid having known concentrations of the two or more dry components; and placing at least a portion of the wellbore servicing fluid into a wellbore penetrating a subterranean formation, wherein (i) the dry composition is a dry fracturing composition and the wellbore servicing fluid is a fracturing fluid, (ii) the dry composition is a dry gravel packing composition and the wellbore servicing fluid is a gravel pack fluid, or (iii) the dry composition is a dry frac-pack composition and the wellbore servicing fluid is a frac-pack fluid. The mixing the all or a portion of the dry composition with the aqueous fluid to form the wellbore servicing fluid and the placing at least a portion of the wellbore servicing fluid into the wellbore penetrating the subterranean formation can comprise a continuous process (also referred to as an “on-the-fly” process). The continuous process can further comprise removing all or a portion of the dry composition from the packaging container.

In some other embodiments, an add-on dry composition can be packaged in a second packaging container separated from the first packaging container. A method for use in oil and gas operations can comprise: dry mixing two or more dry components to form a dry composition, wherein the two or more dry components comprise a polyacrylamide FR polymer and one or more components selected from the group consisting of a gelling polymer, a first portion of one or more dry additives, and combinations thereof, and wherein the dry composition comprises a predetermined ratio of the two or more dry components; placing the dry composition in a first packaging container; prepackaging, in a second packaging container, an add-on dry composition comprising a second portion of the one or more dry additives; transporting the first and second packaging containers to a wellsite; removing all or a portion of the dry composition from the first packaging container; removing all or a portion of the add-on dry composition from the second packaging container; mixing the all or a portion of the dry composition and the all or a portion of the add-on dry composition with an aqueous fluid to form a wellbore servicing fluid having a predetermined ratio of the polyacrylamide FR polymer, the gelling polymer, and the one or more dry additives present in the dry composition and the add-on dry composition; and placing at least a portion of the wellbore servicing fluid into a wellbore penetrating a subterranean formation, wherein (i) the dry composition is a dry fracturing composition and the wellbore servicing fluid is a fracturing fluid, (ii) the dry composition is a dry gravel packing composition and the wellbore servicing fluid is a gravel pack fluid, or (iii) the dry composition is a dry frac-pack composition and the wellbore servicing fluid is a frac-pack fluid. The mixing the all or a portion of the dry composition and the all or a portion of the add-on dry composition with an aqueous fluid to form a wellbore servicing fluid and the placing at least a portion of the wellbore servicing fluid into the wellbore penetrating the subterranean formation can comprise a continuous process (also referred to as an “on-the-fly” process). The continuous process can further comprise removing all or a portion of the dry composition from the first packaging container and removing all or a portion of the add-on dry composition from the second packaging container.

The methods as disclosed herein have various advantages. First, the methods can simplify the process of metering and mixing of all the components for obtaining a designed wellbore servicing fluid, i.e., requiring only one or two pre-blended dry mixtures and an aqueous fluid. Another advantage is the methods disclosed herein can provide prepackaged mixtures of all the dry ingredients required for preparing a wellbore servicing fluid, wherein the polyacrylamide FR polymer and the other components are premixed in the appropriate proportions, so that the mixture of the polyacrylamide FR polymer and the other components can be added directly to water, or an aqueous fluid being pumped down the wellbore into the subterranean formation to enable mixing and pumping on a continuous basis to prepare the desired wellbore servicing fluid without the need for pre-gelling tanks. It can still provide friction reduction performance while having a high injection rate into the wellbore and good proppant suspension as the wellbore servicing fluid is being placed in created fractures. Another advantage is about quality control. Besides the polyacrylamide FR polymer, adding of the other components, such as breaker, surfactant, biocides, etc., will tend to result in poor quality control of the desired wellbore servicing fluid as a result of adding wrong concentration or missing a component. Quality control of the final desired wellbore servicing fluid can be difficult, which often results in errors. The methods give high quality control and high degree of confidence for preparing a wellbore servicing fluid and/or a proppant slurry with the desired performance. Also, on-the-fly preparation of the wellbore servicing fluid and/or the proppant slurry can help to reduce footprints which are often required by pumps, hoses, pre-gelling tanks, etc. In addition, the methods can enhance cost and time savings over conventional methods of adding and mixing separate components for preparing a wellbore servicing fluid and/or a proppant slurry at a wellsite.

Prepackaging of the dry components and dry additives of the wellbore servicing fluid composition as described herein can result in improved quality control of the desired wellbore servicing fluid, for example as a result of adding the proper components in the proper concentrations. Accordingly, quality control of the final desired wellbore servicing fluid is easier and errors less frequent. The process of preparing the wellbore servicing fluid is also simplified, which may require less process equipment including pumps, hoses, pre-gelling tanks, etc. Thus the process of preparing the wellbore servicing fluid may take less time and space, and be more cost effective. Accordingly, the present disclosure provides methods for preparing a wellbore servicing fluid with the correct amount of each component, while reducing footprints required by pumps, hoses, pre-gelling tanks, etc., and while achieving good quality of the wellbore servicing fluid.

Therefore, the methods provide a dry, pre-packaged system to greatly enhance the mixing efficiency, fluid performance, and cost saving of wellbore servicing fluid and/or proppant slurry preparation, and can be a step heading toward automation process.

### ADDITIONAL DISCLOSURE

The following are non-limiting, specific embodiments in accordance with the present disclosure:

A first embodiment, which is a method for use in oil and gas operations comprising prepackaging, in a packaging container, two or more dry components to form a dry composition, wherein the two or more dry components comprise a polyacrylamide friction reducer (FR) polymer, and wherein the dry composition comprises a predetermined ratio of the two or more dry components, transporting the packaging container to a wellsite, removing all or a portion of the dry composition from the packaging container and mixing the all or a portion of the dry composition with an aqueous fluid to form a wellbore servicing fluid having known concentrations of the two or more dry components, and placing at least a portion of the wellbore servicing fluid into a wellbore penetrating a subterranean formation.

A second embodiment, which is the method of the first embodiment, wherein the mixing the all or a portion of the dry composition with an aqueous fluid to form a wellbore servicing fluid and the placing at least a portion of the wellbore servicing fluid into a wellbore penetrating a subterranean formation comprise a continuous process.

A third embodiment, which is the method of the second embodiment, wherein the continuous process further comprises removing all or a portion of the dry composition from the packaging container.

A fourth embodiment, which is the method of any of the first through the third embodiments, wherein the prepackaging further comprises dry mixing the two or more dry components to form the dry composition prior to placing the dry composition into the packaging container.

A fifth embodiment, which is the method of the fourth embodiment, wherein the dry mixing the two or more dry components to form the dry composition is carried out at two or more separate locations.

A sixth embodiment, which is the method of the fifth embodiment, wherein the two or more separate locations comprise a first location of dry mixing a portion of the two or more dry components to form an intermediate dry mixture, and a second location of dry mixing the intermediate dry mixture with another portion of the two or more dry components to form the dry composition.

A seventh embodiment, which is the method of any of the first through the sixth embodiments, further comprising prepackaging, in a second packaging container, an add-on dry composition comprising one or more dry additives, transporting the second packaging container to the wellsite and removing all or a portion of the add-on dry composition from the second packaging container, and prior to placing at least a portion of the wellbore servicing fluid into the wellbore, mixing the all or a portion of the add-on dry composition with the dry composition and the aqueous fluid to form the wellbore servicing fluid having known concentrations of the one or more dry additives.

An eighth embodiment, which is the method of the second or the third embodiment, further comprising prepackaging, in a second packaging container, an add-on dry composition comprising one or more dry additives, transporting the second packaging container to the wellsite and removing all or a portion of the add-on dry composition from the second packaging container, and prior to placing at least a portion of the wellbore servicing fluid into the wellbore, mixing the all or a portion of the add-on dry composition with the dry composition and the aqueous fluid to form the wellbore servicing fluid having known concentrations of the one or more dry additives, wherein the mixing the all or a portion of the add-on dry composition with the dry composition and the aqueous fluid to form the wellbore servicing fluid is part of the continuous process.

A ninth embodiment, which is the method of the eighth embodiment, wherein the removing all or a portion of the add-on dry composition from the second packaging container is part of the continuous process.

A tenth embodiment, which is the method of any of the seventh through the ninth embodiments, wherein the prepackaging, in the packaging container, the two or more dry components to form the dry composition is at a first location and the prepackaging, in the second packaging container, the add-on dry composition comprising the one or more dry additives is at a second location that is separate from the first location.

An eleventh embodiment, which is the method of the sixth embodiment, further comprising prepackaging, in a second packaging container, an add-on dry composition comprising one or more dry additives, transporting the second packaging container to the wellsite and removing all or a portion of the add-on dry composition from the second packaging container; and prior to placing at least a portion of the wellbore servicing fluid into a wellbore, mixing the all or a portion of the add-on dry composition with the dry composition and the aqueous fluid to form the wellbore servicing fluid having known concentrations of the one or more dry additives, wherein the prepackaging, in the second packaging container, the add-on dry composition comprising the one or more dry additives is at a third location that is separate from the first and second locations.

A twelfth embodiment, which is the method of any of the first through the eleventh embodiments, wherein the packaging container(s) are sealed during the transporting and opened at the wellsite.

A thirteenth embodiment, which is the method of any of the first through the twelfth embodiments, wherein the packaging container(s) are selected from the group consisting of totes having a tapered bottom, sacks (e.g., super sacks), railcars (e.g., pneumatic railcars), commercial trailers (e.g., pneumatic trailer, Fruehauf trailers).

A fourteenth embodiment, which is the method of any of the first through the thirteenth embodiments, wherein the dry composition is a dry fracturing composition and the wellbore servicing fluid is a fracturing fluid.

A fifteenth embodiment, which is the method of the fourteenth embodiment, further comprising placing all or a portion of the fracturing fluid into the wellbore, wherein all or a portion of the fracturing fluid flows through a perforated interval of the wellbore and into the subterranean formation as part of a hydraulic fracturing treatment.

A sixteenth embodiment, which is the method of the fourteenth or the fifteenth embodiment, further comprising mixing a proppant with all or a portion of the fracturing fluid to form a proppant slurry, and placing all or a portion of the proppant slurry into the wellbore, wherein all or a portion of the proppant slurry flows through a perforated interval of the wellbore and into the subterranean formation as part of a hydraulic fracturing treatment.

A seventeenth embodiment, which is the method of any of the first through the thirteenth embodiments, wherein the dry composition is a dry gravel packing composition and the wellbore servicing fluid is a gravel packing fluid.

An eighteenth embodiment, which is the method of the seventeenth embodiment, further comprising mixing gravel with all or a portion of the wellbore servicing fluid to form the gravel packing fluid, and placing all or a portion of the gravel packing fluid into the wellbore, wherein the wellbore has a perforated interval having a wellbore screen disposed proximate thereto that forms an annular space between the wellbore wall and the wellbore screen, and wherein the gravel packing fluid flows into the annular space and deposits the gravel therein.

A nineteenth embodiment, which is the method of any of the first through the thirteenth embodiments, wherein the dry composition is a dry frac-pack composition and the wellbore servicing fluid is a frack-pack fluid.

A twentieth embodiment, which is the method of the nineteenth embodiment, further comprising mixing a particulate material with all or a portion of the wellbore servicing fluid to form the frac-pack fluid, and placing all or a portion of the frac-pack fluid into the wellbore, wherein the wellbore has a perforated interval having a wellbore screen disposed proximate thereto that forms an annular space between the wellbore wall and the wellbore screen, and wherein the frac-pack fluid flows into the annular space and through a perforated interval of the wellbore and into the subterranean formation, and wherein the particulate material is deposited into the subterranean formation as part of a hydraulic fracturing treatment and the particulate material is deposited in the annular space as part of a gravel packing treatment.

A twenty-first embodiment, which is the method of any of the first through the twentieth embodiments, wherein the polyacrylamide FR polymer comprises at least one polymer selected from the group consisting of: a polyacrylamide, a polyacrylamide derivative, a polyacrylamide co-polymer, and combinations thereof.

A twenty-second embodiment, which is the method of any of the first through the twentieth embodiments, wherein the polyacrylamide FR polymer is an anionic, cationic, non-ionic, or amphoteric polymer.

A twenty-third embodiment, which is the method of any of the first through the twentieth embodiments, wherein the polyacrylamide FR polymer comprises at least one monomer derived from a compound selected from the group consisting of a carboxylic acid-substituted (C₂-C₂₀)alkene; a (C₂-C₂₀)alkylene oxide; a ((C₁-C₂₀)hydrocarbyl (C₁-C₂₀)alkanoic acid ester)-substituted (C₂-C₂₀)alkene; a ((C₁-C₂₀)alkanoic acid salt)-substituted (C₂-C₂₀)alkene; a (C₁-C₂₀)alkanoyloxy(C₁-C₂₀)hydrocarbyl tri(C₁-C₂₀)hydrocarbylammonium salt; a (substituted or unsubstituted amide)-substituted (C₂-C₂₀)alkene; a sulfonic acid-, sulfonic acid (C₁-C₂₀)hydrocarbyl ester-, or sulfonic acid salt-substituted (C₂-C₂₀)alkene; a (sulfonic acid (C₁-C₂₀)hydrocarbyl ester-, or sulfonic acid salt-substituted (C₁-C₂₀)hydrocarbylamido)-substituted (C₂-C₂₀)alkene; an N—(C₂-C₂₀)alkenyl (C₂-C₂₀)alkanoic acid amide; and a mono-, di-, tri-, or tetra-(C₂-C₂₀)alkenyl-substituted ammonium salt wherein the ammonium group is further substituted or unsubstituted; and combinations thereof; wherein each hydrocarbyl, alkene, alkylene, alkanoic, and alkanoyl group is independently interrupted or terminated with 0, 1, 2, or 3 groups chosen from —O—, —NH—, and —S—, wherein each hydrocarbyl, alkene, alkylene, alkanoic, and alkanoyl group is independently further substituted or further unsubstituted.

A twenty-fourth embodiment, which is the method of any of the first through the twentieth embodiments, wherein the polyacrylamide FR polymer comprises at least one monomer derived from a compound selected from the group consisting of acrylamide, acrylic acid or a salt thereof, 2-acrylamido-2-methylpropane sulfonic acid or a salt thereof, N,N-dimethylacrylamide, vinyl sulfonic acid or a salt thereof, N-vinyl acetamide, N-vinyl formamide, itaconic acid or a salt thereof, methacrylic acid or a salt thereof, acrylic acid ester, methacrylic acid ester, diallyl dimethyl ammonium chloride, dimethylaminoethyl acrylate, acryloyloxy ethyl trimethyl ammonium chloride, ethylene oxide, 2-(2-ethoxyethoxy)-ethyl acrylate, and combinations thereof.

A twenty-fifth embodiment, which is the method of any of the first through the twentieth embodiments, wherein the polyacrylamide FR polymer is a polymer comprising about Z1 mol % of an ethylene repeating unit comprising a —C(O)NHR¹ group and comprising about N1 mol % of an ethylene repeating unit comprising a —C(O)R² group, wherein at each occurrence R¹ is independently a substituted or unsubstituted C₅-C₅₀ hydrocarbyl, at each occurrence R² is independently selected from a group consisting of —NH₂ and OR³, wherein at each occurrence R³ is independently selected from a group consisting of —R′, —H, and a counterion; wherein the ethylene repeating units are in block, alternate, or random configuration, and wherein Z1 mol % is from about 0.001% to about 50%, N1 mol % is from about 50% to about 99.999%, and Z1+N1 mol % is about 100%.

A twenty-sixth embodiment, which is the method of any of the first through the twenty-fifth embodiments, wherein the two or more dry components further comprise one or more dry additives.

A twenty-seventh embodiment, which is the method of any of the seventh through the twenty-sixth embodiments, wherein the one or more dry additives comprise a surfactant, a breaker, a pH-adjusting agent, an anti-caking agent, a diverting or bridging agent, a chelating agent, a biocide, a de-emulsifier, a salt, a crosslinking agent, an anti-moisture agent, a degradable or non-degradable fiber material, a buffer, a clay inhibitor, an iron-control additive, a caustic, a scale inhibitor, a corrosion inhibitor, a relative permeability modifier, a curable resin, a resin activator, a tackifying agent, a surface modification agent, a nano-particle, or combinations thereof.

A twenty-eighth embodiment, which is the method of the twenty-seventh embodiment, wherein the surfactant comprises an anionic surfactant selected from a group consisting of sodium lauryl sulfate, alpha olefin sulfonate, alkylether sulfates, alkyl phosphonates, alkane sulfonates, fatty acid salts, arylsulfonic acid salts, and combinations thereof a cationic surfactant selected from a group consisting of trimethylcocoammonium chloride, trimethyltallowammonium chloride, dimethyldicocoammonium chloride, bis(2-hydroxyethyl)tallow amine, bis(2-hydroxyethyl)erucylamine, bis(2-hydroxyethyl)coco-amine, cetylpyridinium chloride, and combinations thereof or combinations thereof.

A twenty-ninth embodiment, which is the method of any of the twenty-seventh and the twenty-eighth embodiments, wherein the weight ratio of the polyacrylamide FR polymer to the surfactant is in a range of from about 0.1:10 to about 10:1, alternatively in a range of from about 1:5 to about 5:1.

A thirtieth embodiment, which is the method of any of the twenty-seventh through the twenty-ninth embodiments, wherein the breaker comprises an instant breaker, a delayed breaker, or combinations thereof.

A thirty-first embodiment, which is the method of any of the twenty-seventh through the twenty-ninth embodiments, wherein the breaker comprises an oxidizer, an acid, an enzyme, or combinations thereof.

A thirty-second embodiment, which is the method of any of the twenty-seventh through the twenty-ninth embodiments, wherein the breaker comprises a hemicellulase enzyme, sodium persulfate, sodium perborate, ammonium persulfate, sodium chlorite, citric acid, citrate, fumaric acid, perborates, peroxides, or combinations thereof.

A thirty-third embodiment, which is the method of any of the twenty-seventh through the thirty-second embodiments, wherein the weight ratio of the polyacrylamide FR polymer to the breaker is in a range of from about 0.1:10 to about 10:1, alternatively in a range of from about 1:5 to about 5:1.

A thirty-fourth embodiment, which is the method of any of the twenty-seventh through the thirty-third embodiments, wherein the anti-caking agent comprises a particulate solid material selected from a group consisting of precipitated silica, zeolite, magnesium stearate, calcium stearate, aluminum stearate, docusate sodium, sodium bicarbonate, cellulose, tricalcium phosphate, sodium ferrocyanide, potassium ferrocyanide, sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, polydimethylsiloxane, diatomaceous earth, sodium chloride, vermiculite, magnesium sulfate, and calcium sulfate.

A thirty-fifth embodiment, which is the method of any of the twenty-seventh through the thirty-fourth embodiments, wherein the anti-caking agent can be present in the dry composition and/or in the add-on dry composition in a range of from about 0.01 wt. % to about 1 wt. %, based on the total weight of the dry composition and/or in the add-on dry composition, alternatively in a range of from about 0.01 wt. % to about 0.9 wt. %, alternatively in a range of from about 0.01 wt. % to about 0.7 wt. %.

A thirty-sixth embodiment, which is the method of any of the twenty-seventh through the thirty-fifth embodiments, wherein the crosslinking agent is selected from a group consisting of boron compounds, compounds that supply zirconium IV ions, compounds that supply titanium IV ions, aluminum compounds, compounds that supply antimony ions, and combinations thereof.

A thirty-seventh embodiment, which is the method of any of the twenty-seventh through the thirty-sixth embodiments, wherein the weight ratio of the polyacrylamide FR polymer to the crosslinking agent is in a range of from about 0.1:10 to about 10:1, alternatively in a range of from about 1:5 to about 5:1.

A thirty-eighth embodiment, which is the method of any of the twenty-seventh through the thirty-seventh embodiments, wherein the degradable or non-degradable fiber material comprises vegetable fibers, wood fibers, human fibers, animal fibers, mineral fibers, metallic fibers, carbon fibers, silicon carbide fibers, fiberglass fibers, cellulose fibers, polymer fibers, polyamide fibers, nylon fibers, polyethylene fibers, polypropylene fibers, polyethylene terephthalate fibers, poly(vinyl alcohol) fibers, polyolefin fibers, acrylic polyester fibers, aromatic polyamide fibers, elastomeric polymer fibers, glass fibers, polyurethane fibers, or combinations thereof.

A thirty-ninth embodiment, which is the method of any of the twenty-seventh through the thirty-eighth embodiments, wherein the weight ratio of the polyacrylamide FR polymer to the degradable or non-degradable fiber material is in a range of from about 0.1:10 to about 10:1, alternatively in a range of from about 1:5 to about 5:1.

A fortieth embodiment, which is the method of any of the twenty-seventh through the thirty-ninth embodiments, wherein the diverting or bridging agent comprises a fine sand, a degradable polymer, or combinations thereof.

A forty-first embodiment, which is the method of any of the twenty-seventh through the thirty-ninth embodiments, wherein the diverting or bridging agent comprises at least one polymer selected from a group consisting of a polysaccharide, chitin, chitosan, a protein, an orthoester, an aliphatic polyester, a polyglycolide, polylactide, poly(vinyl alcohol), an esterified poly(vinyl alcohol), polycaprolactone, polyhydroxybutyrate, a polyanhydride, an aliphatic polycarbonate, a polyorthoester, a poly(amino acid), a poly(ethylene oxide), a polyphosphazene, a copolymer including monomers from at least two polymers chosen from the group, and combinations thereof.

A forty-second embodiment, which is the method of any of the twenty-seventh through the forty-first embodiments, wherein the diverting or bridging agent has a shape of platelets, shavings, flakes, ribbons, rods, strips, spheroids, toroids, pellets, tablets, or any other physical shape.

A forty-third embodiment, which is the method of any of the twenty-seventh through the forty-second embodiments, wherein the weight ratio of the polyacrylamide FR polymer to the diverting or bridging agent is in a range of from about 0.1:10 to about 10:1, alternatively in a range of from about 1:5 to about 5:1.

A forty-fourth embodiment, which is the method of any of the first through the forty-third embodiments, wherein the two or more dry components further comprise a gelling polymer.

A forty-fifth embodiment, which is the method of the forty-fourth embodiment, wherein the gelling polymer comprises a guar-based polymer (e.g., guar, hydroxypropyl guar, carboxymethyl guar, carboxymethylhydroxyethyl guar); a cellulose derivative selected from a group consisting of carboxymethylcellulose, carboxymethylhydroxyethylcellulose, hydroxyethylcellulose, methylhydroxypropylcellulose, methylcellulose, ethylcellulose, propylcellulose, ethylcarboxymethylcellulose, methylethylcellulose, hydroxypropylmethylcellulose, and combinations thereof a biopolymer selected from a group consisting of xanthan, scleroglucan, succinoglycan, and combinations thereof or combinations thereof.

A forty-sixth embodiment, which is the method of the forty-fourth or the forty-fifth embodiment, wherein the weight ratio of the polyacrylamide FR polymer to the gelling polymer is in a range of from about 0.1:10 to about 10:1, alternatively in a range of from about 1:5 to about 5:1.

A forty-seventh embodiment, which is the method of any of the first through the forty-sixth embodiments, wherein the aqueous fluid comprises water selected from the group consisting of freshwater, saltwater, brine, seawater, and combinations thereof.

A forty-eighth embodiment, which is the method of any of the first through the forty-seventh embodiments, wherein the aqueous fluid is present in the wellbore servicing fluid in an amount of from about 1 wt. % to about 99.99 wt. %, alternatively from about 30 wt. % to about 99 wt. %, alternatively from about 50 wt. % to about 90 wt. %.

A forty-ninth embodiment, which is the method of any of the sixteenth through the forty-eighth embodiments, wherein the proppant comprises a naturally-occurring material, a synthetic material, or a combination thereof.

A fiftieth embodiment, which is the method of any of the sixteenth through the forty-eighth embodiments, wherein the proppant comprises silica (sand), graded sand, Ottawa sands, Brady sands, Colorado sands; resin-coated sands; gravels; synthetic organic particles, nylon pellets, high density plastics, teflons, rubbers, resins; ceramics, aluminosilicates; glass; sintered bauxite; quartz; aluminum pellets; ground or crushed shells of nuts; ground or crushed seed shells; crushed fruit pits; processed wood materials; or combinations thereof.

A fifty-first embodiment, which is the method of any of the sixteenth through the fiftieth embodiments, wherein the proppant has a mean particle size in the range of from about 2 to about 800 mesh, alternatively from about 8 to about 200 mesh, or alternatively from about 10 to about 70 mesh, U.S. Sieve Series.

A fifty-second embodiment, which is the method of any of the sixteenth through the fifty-first embodiments, wherein the proppant is present in the proppant slurry in an amount of to provide a proppant concentration ranging from greater than 0 pounds per gallon (ppg) to about 20 ppg, alternatively from about 0.1 ppg to about 8 ppg, or alternatively from about 0.5 ppg to about 4 ppg, based on the total weight of the proppant slurry.

A fifty-third embodiment, which is the method of any of the eighteenth through the forty-eighth embodiments, wherein the gravel is in an amount of from about 0.1 pounds per gallon (ppg) to about 30 ppg, alternatively from about 1 ppg to about 15 ppg, or alternatively from about 1 ppg to about 10 ppg, based on the total weight of the gravel packing fluid.

A fifty-fourth embodiment, which is the method of any of the twentieth through the forty-eighth embodiments, wherein the particulate material is in an amount of from greater than 0.1 pounds per gallon (ppg) to about 30 ppg, alternatively from about 0.5 ppg to about 15 ppg, or alternatively from about 1 ppg to about 10 ppg, based on the total weight of the frac-pack fluid.

A fifty-fifth embodiment, which is a method for use in oil and gas operations comprising dry mixing two or more dry components to form a dry composition, wherein the two or more dry components comprise a polyacrylamide FR polymer and one or more components selected from the group consisting of a gelling polymer, one or more dry additives, and combinations thereof, and wherein the dry composition comprises a predetermined ratio of the two or more dry components, placing the dry composition in a packaging container, transporting the packaging container to a wellsite, removing all or a portion of the dry composition from the packaging container, mixing the all or a portion of the dry composition with an aqueous fluid to form a wellbore servicing fluid having known concentrations of the two or more dry components, and placing at least a portion of the wellbore servicing fluid into a wellbore penetrating a subterranean formation, wherein (i) the dry composition is a dry fracturing composition and the wellbore servicing fluid is a fracturing fluid, (ii) the dry composition is a dry gravel packing composition and the wellbore servicing fluid is a gravel packing fluid, or (iii) the dry composition is a dry frac-pack composition and the wellbore servicing fluid is a frac-pack fluid.

A fifty-sixth embodiment, which is the method of fifty-fifth embodiment, wherein the mixing the all or a portion of the dry composition with the aqueous fluid to form the wellbore servicing fluid and the placing at least a portion of the wellbore servicing fluid into the wellbore penetrating the subterranean formation comprise a continuous process (also referred to as an “on-the-fly” process).

A fifty-seventh embodiment, which is the method of the fifty-sixth embodiment, wherein the continuous process further comprises removing all or a portion of the dry composition from the packaging container.

A fifty-eighth embodiment, which is a method for use in oil and gas operations comprising dry mixing two or more dry components to form a dry composition, wherein the two or more dry components comprise a polyacrylamide FR polymer and one or more components selected from the group consisting of a gelling polymer, a first portion of one or more dry additives, and combinations thereof, and wherein the dry composition comprises a predetermined ratio of the two or more dry components, placing the dry composition in a first packaging container, prepackaging, in a second packaging container, an add-on dry composition comprising a second portion of the one or more dry additives, transporting the first and second packaging containers to a wellsite, removing all or a portion of the dry composition from the first packaging container, removing all or a portion of the add-on dry composition from the second packaging container, mixing the all or a portion of the dry composition and the all or a portion of the add-on dry composition with an aqueous fluid to form a wellbore servicing fluid having a predetermined ratio of the polyacrylamide FR polymer, the gelling polymer, and the one or more dry additives present in the dry composition and the add-on dry composition, and placing at least a portion of the wellbore servicing fluid into a wellbore penetrating a subterranean formation, wherein (i) the dry composition is a dry fracturing composition and the wellbore servicing fluid is a fracturing fluid, (ii) the dry composition is a dry gravel packing composition and the wellbore servicing fluid is a gravel packing fluid, or (iii) the dry composition is a dry frac-pack composition and the wellbore servicing fluid is a frac-pack fluid.

A fifty-ninth embodiment, which is the method of the fifty-eighth embodiment, wherein the mixing the all or a portion of the dry composition and the all or a portion of the add-on dry composition with an aqueous fluid to form a wellbore servicing fluid and the placing at least a portion of the wellbore servicing fluid into the wellbore penetrating the subterranean formation comprise a continuous process (also referred to as an “on-the-fly” process).

A sixtieth embodiment, which is the method of the fifty-ninth embodiment, wherein the continuous process further comprises removing all or a portion of the dry composition from the first packaging container and removing all or a portion of the add-on dry composition from the second packaging container.

While embodiments of the disclosure have been shown and described, modifications thereof can be made by one skilled in the art without departing from the spirit and teachings of the disclosure. The embodiments described herein are exemplary only, and are not intended to be limiting. Many variations and modifications of the disclosure disclosed herein are possible and are within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k* (R_{U}-R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. When a feature is described as “optional,” both embodiments with this feature and embodiments without this feature are disclosed. Similarly, the present disclosure contemplates embodiments where this feature is required and embodiments where this feature is specifically excluded. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the embodiments of the present disclosure.

What is claimed is:

1. A method for use in oil and gas operations comprising:
prepackaging, in a packaging container, two or more dry components to form a dry composition, wherein the two or more dry components comprise a polyacrylamide friction reducer (FR) polymer, and wherein the dry composition comprises a predetermined ratio of the two or more dry components;
transporting the packaging container to a wellsite;
removing all or a portion of the dry composition from the packaging container and mixing the all or a portion of the dry composition with an aqueous fluid to form a wellbore servicing fluid having known concentrations of the two or more dry components; and
placing at least a portion of the wellbore servicing fluid into a wellbore penetrating a subterranean formation.

2. The method of claim 1, wherein the mixing the all or a portion of the dry composition with an aqueous fluid to form a wellbore servicing fluid and the placing at least a portion of the wellbore servicing fluid into a wellbore penetrating a subterranean formation comprise a continuous process.

3. The method of claim 2, wherein the continuous process further comprises removing all or a portion of the dry composition from the packaging container.

4. The method of claim 1, wherein the prepackaging further comprises dry mixing the two or more dry components to form the dry composition prior to placing the dry composition into the packaging container.

5. The method of claim 4, wherein the dry mixing the two or more dry components to form the dry composition is carried out at two or more separate locations.

6. The method of claim 5, wherein the two or more separate locations comprise a first location of dry mixing a portion of the two or more dry components to form an intermediate dry mixture, and a second location of dry mixing the intermediate dry mixture with another portion of the two or more dry components to form the dry composition.

7. The method of claim 1, further comprising:
prepackaging, in a second packaging container, an add-on dry composition comprising one or more dry additives;
transporting the second packaging container to the wellsite and removing all or a portion of the add-on dry composition from the second packaging container; and
prior to placing at least a portion of the wellbore servicing fluid into the wellbore, mixing the all or a portion of the add-on dry composition with the dry composition and the aqueous fluid to form the wellbore servicing fluid having known concentrations of the one or more dry additives.

8. The method of claim 2, further comprising:
prepackaging, in a second packaging container, an add-on dry composition comprising one or more dry additives;
transporting the second packaging container to the wellsite and removing all or a portion of the add-on dry composition from the second packaging container; and
prior to placing at least a portion of the wellbore servicing fluid into the wellbore, mixing the all or a portion of the add-on dry composition with the dry composition and the aqueous fluid to form the wellbore servicing fluid having known concentrations of the one or more dry additives,
wherein the mixing the all or a portion of the add-on dry composition with the dry composition and the aqueous fluid to form the wellbore servicing fluid is part of the continuous process.

9. The method of claim 8, wherein the removing all or a portion of the add-on dry composition from the second packaging container is part of the continuous process.

10. The method of claim 7, wherein the prepackaging, in the packaging container, the two or more dry components to form the dry composition is at a first location and the prepackaging, in the second packaging container, the add-on dry composition comprising the one or more dry additives is at a second location that is separate from the first location.

11. The method of claim 6, further comprising:
prepackaging, in a second packaging container, an add-on dry composition comprising one or more dry additives;
transporting the second packaging container to the wellsite and removing all or a portion of the add-on dry composition from the second packaging container; and
prior to placing at least a portion of the wellbore servicing fluid into a wellbore, mixing the all or a portion of the add-on dry composition with the dry composition and the aqueous fluid to form the wellbore servicing fluid having known concentrations of the one or more dry additives,
wherein the prepackaging, in the second packaging container, the add-on dry composition comprising the one or more dry additives is at a third location that is separate from the first and second locations.

12. The method of claim 1, wherein the dry composition is a dry fracturing composition and the wellbore servicing fluid is a fracturing fluid, and further comprising placing all or a portion of the fracturing fluid into the wellbore, wherein all or a portion of the fracturing fluid flows through a perforated interval of the wellbore and into the subterranean formation as part of a hydraulic fracturing treatment.

13. The method of claim 1, wherein the dry composition is a dry gravel packing composition and the wellbore servicing fluid is a gravel packing fluid, and further comprising:
mixing gravel with all or a portion of the wellbore servicing fluid to form the gravel packing fluid; and
placing all or a portion of the gravel packing fluid into the wellbore, wherein the wellbore has a perforated interval having a wellbore screen disposed proximate thereto that forms an annular space between the wellbore wall and the wellbore screen, and wherein the gravel packing fluid flows into the annular space and deposits the gravel therein.

14. The method of claim 1, wherein the dry composition is a dry frac-pack composition and the wellbore servicing fluid is a frack-pack fluid, and further comprising:
mixing a particulate material with all or a portion of the wellbore servicing fluid to form the frac-pack fluid; and
placing all or a portion of the frac-pack fluid into the wellbore, wherein the wellbore has a perforated interval having a wellbore screen disposed proximate thereto that forms an annular space between the wellbore wall and the wellbore screen, and wherein the frac-pack fluid flows into the annular space and through a perforated interval of the wellbore and into the subterranean formation, and wherein the particulate material is deposited into the subterranean formation as part of a hydraulic fracturing treatment and the particulate material is deposited in the annular space as part of a gravel packing treatment.

15. A method for use in oil and gas operations comprising:
dry mixing two or more dry components to form a dry composition, wherein the two or more dry components comprise a polyacrylamide FR polymer and one or more components selected from the group consisting of a gelling polymer, one or more dry additives, and combinations thereof, and wherein the dry composition comprises a predetermined ratio of the two or more dry components;
placing the dry composition in a packaging container;
transporting the packaging container to a wellsite;
removing all or a portion of the dry composition from the packaging container;
mixing the all or a portion of the dry composition with an aqueous fluid to form a wellbore servicing fluid having known concentrations of the two or more dry components; and
placing at least a portion of the wellbore servicing fluid into a wellbore penetrating a subterranean formation,
wherein (i) the dry composition is a dry fracturing composition and the wellbore servicing fluid is a fracturing fluid, (ii) the dry composition is a dry gravel packing composition and the wellbore servicing fluid is a gravel packing fluid, or (iii) the dry composition is a dry frac-pack composition and the wellbore servicing fluid is a frac-pack fluid.

16. The method of claim 15, wherein the mixing the all or a portion of the dry composition with the aqueous fluid to form the wellbore servicing fluid and the placing at least a portion of the wellbore servicing fluid into the wellbore penetrating the subterranean formation comprise a continuous process (also referred to as an “on-the-fly” process).

17. The method of claim 16, wherein the continuous process further comprises removing all or a portion of the dry composition from the packaging container.

18. A method for use in oil and gas operations comprising:
dry mixing two or more dry components to form a dry composition, wherein the two or more dry components comprise a polyacrylamide FR polymer and one or more components selected from the group consisting of a gelling polymer, a first portion of one or more dry additives, and combinations thereof, and wherein the dry composition comprises a predetermined ratio of the two or more dry components;
placing the dry composition in a first packaging container;
prepackaging, in a second packaging container, an add-on dry composition comprising a second portion of the one or more dry additives;
transporting the first and second packaging containers to a wellsite;
removing all or a portion of the dry composition from the first packaging container;
removing all or a portion of the add-on dry composition from the second packaging container;
mixing the all or a portion of the dry composition and the all or a portion of the add-on dry composition with an aqueous fluid to form a wellbore servicing fluid having a predetermined ratio of the polyacrylamide FR polymer, the gelling polymer, and the one or more dry additives present in the dry composition and the add-on dry composition; and
placing at least a portion of the wellbore servicing fluid into a wellbore penetrating a subterranean formation,
wherein (i) the dry composition is a dry fracturing composition and the wellbore servicing fluid is a fracturing fluid, (ii) the dry composition is a dry gravel packing composition and the wellbore servicing fluid is a gravel packing fluid, or (iii) the dry composition is a dry frac-pack composition and the wellbore servicing fluid is a frac-pack fluid.

19. The method of claim 18, wherein the mixing the all or a portion of the dry composition and the all or a portion of the add-on dry composition with an aqueous fluid to form a wellbore servicing fluid and the placing at least a portion of the wellbore servicing fluid into the wellbore penetrating the subterranean formation comprise a continuous process (also referred to as an “on-the-fly” process).

20. The method of claim 19, wherein the continuous process further comprises removing all or a portion of the dry composition from the first packaging container and removing all or a portion of the add-on dry composition from the second packaging container.
